(19) United States
(12) Patent Application Publication
(10) Pub. No.: US 2009/0165995 A1
(43) Pub. Date: Jul. 2, 2009

(54) AIR-OIL HEAT EXCHANGER PLACED AT THE LOCATION OF THE AIR SEPARATOR NOSE OF A TURBOJET, AND A TURBOJET INCLUDING SUCH AN AIR-OIL HEAT EXCHANGER

(75) Inventors: Denis Bajusz, Liege (BE); Albert Cornet, Verviers (BE); Jerome Friedel, Blandy Les Tours (FR); Nicolas Raimarckers, Tourinne (BE)

Correspondence Address: OBLON, SPIVAK, MCCLELLAND MAIER & NEUSTADT, P.C., 1940 DUKE STREET, ALEXANDRIA, VA, 22314, US

(73) Assignee: TECHSPACE AERO, MILMORT HERSTAL (BE)

(21) Appl. No.: 12/342,206

(22) Filed: Dec. 23, 2008

(30) Foreign Application Priority Data
Dec. 27, 2007 (EP) 07150441.9

(51) Int. Cl. F01N 5/02; F02C 7/14; F02C 7/12; F02C 1/00

(52) U.S. Cl. 165/51; 60/39.08; 60/39.83; 60/772

(57) ABSTRACT

The invention relates to an air-oil heat exchanger located at the inner shroud of the secondary duct of a turbojet. In characteristic manner, it comprises an oil circuit placed inside the separator nose and fins placed outside the top wall of the separator nose, between the leading edge of the separator nose and the outlet guide vanes.

### FIELD OF THE INVENTION

The invention relates to an air-oil heat exchanger for cooling the oil of an engine and/or of equipment installed in the engine (electrical equipment, gearboxes, etc.), the heat-exchanger being located at the inner shroud of the secondary duct of a turbojet, preferably at the location of the air separator nose.

The invention also relates to a turbojet including such an air-oil heat exchanger.

### BACKGROUND OF THE INVENTION

The air separator nose situated downstream from the fan serves to separate the primary air stream flowing in the primary duct from the secondary air stream flowing in the secondary duct.

In a turbomachine, various members and pieces of equipment need to be lubricated and/or cooled, with the heat generated generally being conveyed by oil systems and being dumped by oil-cooled or air-cooled heat exchangers. An air-cooled oil cooler (ACOC) involves forcing a stream of air over a heat exchange surface added to the oil circuit.

In order to provide an ACOC, there exist various air feed techniques involving scoops, or air takeoffs tapping the air stream. Nevertheless, not only is the drag of the airplane increased when using a scoop external to the engine, but the aerodynamic disturbance imparted to the air stream by an air takeoff also leads to a drop in the overall efficiency of the engine.

However, such an air-oil heat exchanger is nowadays unavoidable as an additional system for cooling the oil of the engine circuit, over and above the cooling performed by the oil-fuel heat exchangers. Modern engines generate more and more heat, in particular in the following locations:
enclosures for bearings that are subjected to ever increasing levels of mechanical stress;
gearboxes involving high powers; and
incorporating new high-power electrical machines, in particular starter/generators (SIGs) for electrically powering the turbomachine, the power plant system (PPS) (i.e. the engine and its pod), and/or the airplane, and also serving in some configurations, for starting the engine.

In order to minimize performance losses associated with the ACOC or its scoop intruding into the engine duct, use is made nowadays of surface heat exchangers that present less of an aerodynamic obstacle in the duct, so that the air flow can reestablish itself in natural manner. Nevertheless, installing such heat exchangers can lead to constraints involving integration with the walls of the duct (housings, pod cowls), or to a reduction in the areas that are effective in treating sound. There is therefore a need to optimize the positioning and the functions of such heat exchangers.

For the purpose of cooling the oil of the heat exchanger, document U.S. Pat. No. 3,797,561 or FR 2 110 172 discloses making use of an annular tank situated inside the rear portion of the air separator nose and having walls that define internal and external annular channels in contact with those walls of the separator nose along which air from the fan duct flows, thereby serving to cool the oil flowing in the channels. That solution does not enable the separator nose to be de-iced, nor does it optimize the aero-thermal performance of the heat exchanger.

In document CA 2 471 259, the nose of the pod is fitted with an annular duct for oil flow that is received in the pod and that serves simultaneously to cool the oil and to prevent icing of the nose of the pod.

Nevertheless, such a solution would not provide sufficient oil cooling capacity if it were to be implemented in the separator nose.

A system for de-icing the separator nose is described in document U.S. Pat. No. 6,561,760. The de-icing system described in that document makes use of hot air coming from hot portions of the engine. The drawback of that type of solution is that it gives rise to a loss of efficiency associated with tapping the air, and it represents an additional weight.

### OBJECT AND SUMMARY OF THE INVENTION

An object of the invention is to provide an air-oil heat exchanger making it possible to satisfy needs for cooling the oil circuit of the turbojet, while also preventing icing of the separator nose, and to do this without significantly disturbing the air stream.

To this end, according to the present invention, the air-oil heat exchanger comprises an oil circuit placed inside the separator nose and fins placed outside the top wall of the separator nose, between the leading edge of the separator nose and the outlet guide vanes (OGVs).

In this way, it can be understood that the air-oil heat exchanger is located at the inner shroud of the secondary duct, in a zone that extends from the front portion of the separator nose as far as the support struts.

Preferably, the air-oil heat exchanger is located at the front portion of the separator nose.

Thus, in particular by incorporating the oil circuit inside the separator nose, use is made of available space while minimizing disturbance to the air stream by the fins.

Since the fins receive the secondary air stream in its farthest upstream portion, the air that is used for cooling the oil circuit is still very cold. Furthermore, the fins constitute a heat exchange zone presenting a large heat exchange area that disturbs the air stream very little, and that disturbs only the secondary air stream.

In addition to cooling the oil circuit, this solution presents the additional advantage of de-icing the separator nose. The air-oil heat exchanger of the invention forms an anti-icing device for the separator nose and for the inlet guide vanes (IGVs) situated beneath the bottom portion of the separator nose, making use of the heat delivered by the oil circuit to the front portion of the separator nose.

Thus, the present invention also relates to the use of an air-oil heat exchanger of the above-specified type for de-icing the separator nose.

It should be observed that since the air-oil heat exchanger of the invention is situated downstream from the fan and in the portion situated towards the inside of the secondary duct, it has practically no risk of being damaged by foreign bodies penetrating into the turbojet, since it is the fan that absorbs the impact, and by its rotary motion breaks such bodies into small pieces, which pieces are then entrained downstream from the fan and by centrifugal force towards the outside of the secondary duct.

### BRIEF DESCRIPTION OF THE DRAWINGS

Other advantages and characteristics of the invention appear on reading the following description made by way of example and with reference to the accompanying drawings, in which:

FIG. 1 is a general section view of a turbojet serving to situate the location of the air-oil heat exchanger of the invention;

FIG. 2 is a fragmentary perspective view of an angular sector of an air-oil heat exchanger of the invention in a first embodiment;

FIG. 3 is a view of the front portion of the separator nose of FIG. 2, shown in a deployed configuration showing the oil circuit by transparency;

FIG. 4 is a radial half-section of the front portion of the separator nose in a variant of the first embodiment;

FIG. 5 is a fragmentary section of an angular sector of the air-oil heat exchanger on direction V-V in FIG. 4;

FIGS. 6 and 7 are views similar to FIGS. 2 and 3 for a second embodiment of the air-oil heat exchanger of the invention;

FIG. 8 is a section view on direction VIII-VIII of FIG. 7; and

FIG. 9 is a view similar to that of FIG. 2 for a third embodiment of the air-oil heat exchanger of the invention.

### MORE DETAILED DESCRIPTION

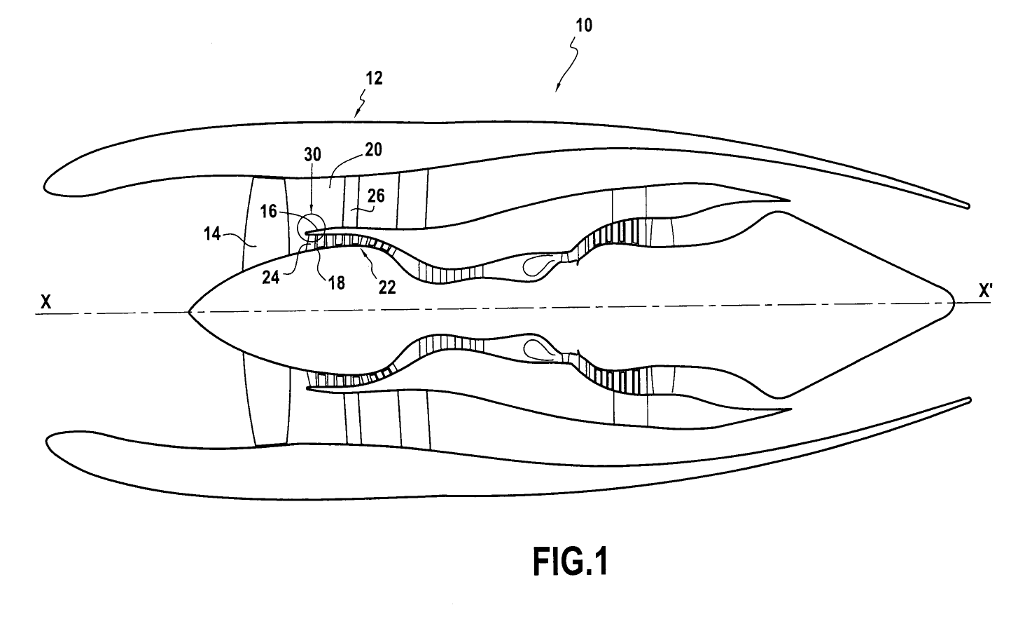

With reference to FIG. 1, a turbojet 10 is shown in highly diagrammatic manner. Its pod 12 serves as an outer casing for various members, including the fan 14 at the front (to the left in FIG. 1).

Downstream from the fan 14, the air stream is separated by the separator nose 16 into a primary air stream and a secondary air stream. The primary air stream travels along an inner annular air passage or primary duct 18 penetrating into the low pressure compressor 22 via inlet guide vanes (IGVs) 24. The secondary air stream is deflected by the separator nose 18 into an outer annular air passage 20 (secondary duct) towards the outlet guide vanes (OGVs) 26 and then towards the outlet from the engine.

In the description below, the various embodiments of the air-oil heat exchanger of the invention are described in greater detail, which heat exchanger is located in zone 30 of FIG. 1, i.e. in the front portion 161 of the separator nose 16.

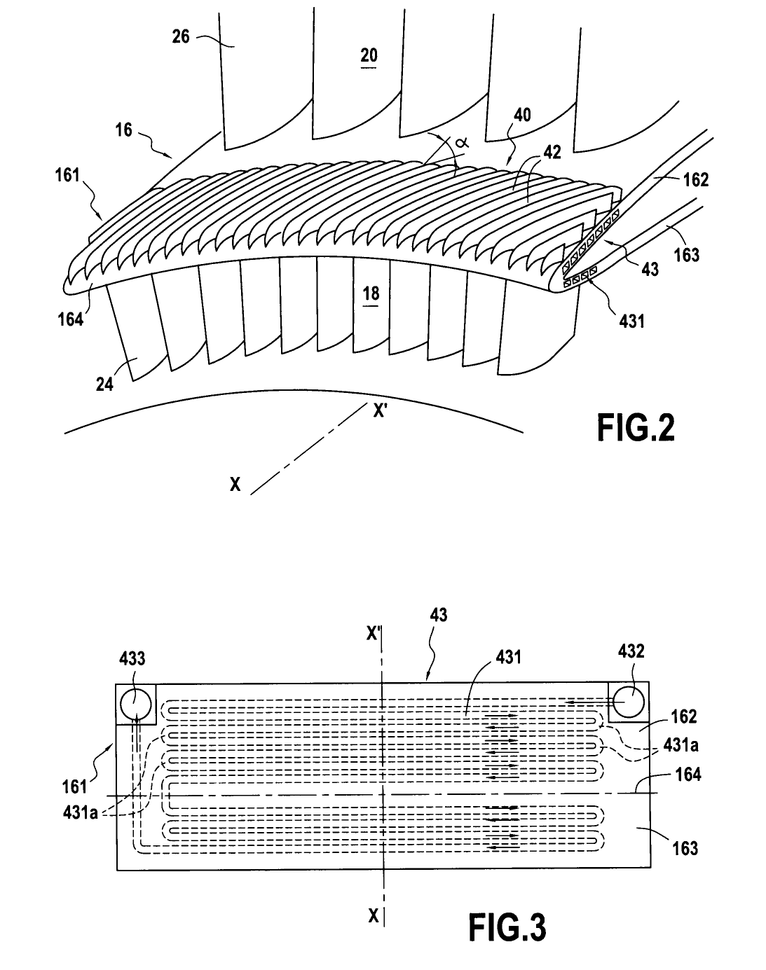

FIG. 2 shows more clearly the front portion 161 of the separator nose 16 comprising the leading edge 164 situated farthest upstream where the top wall 162 of the separator nose 16 meets the bottom wall 163 of the separator nose 16, the top wall 162 forming the inner shroud of the secondary duct 20.

The term “top” is used herein to mean any element situated towards the outside on a radial axis originating on the axis X-X′ of the turbojet 10, and the term “bottom” designates any element situated towards the inside on a radial axis originating on the axis X-X′ of the turbojet 10.

The terms “upstream” and “downstream” relate to axial positions along the axis X-X′ in the flow direction of the air stream through the turbojet 10.

The separator nose 16 is hollow, the top face of the top wall 162 acting as the radially inner boundary of the outer annular air passage 20 that receives the secondary stream, while the bottom face of the bottom wall 163 serves as the radially outer boundary of the inner annular air passage 18 that receives the primary stream.

The bottom wall 163 of the separator nose 16 forms the outer shroud of the low pressure compressor 22.

The outlet guide vanes 26 are offset axially downstream relative to the leading edge 164 of the separator nose 16 such that, conventionally, the top face of the top wall 162 is clear in the fraction of the front portion 161 that is directly adjacent to the leading edge 164 of the separator nose 16.

It is in this fraction of the front portion 161 that is directly adjacent to the leading edge 164 of the separator nose 16, situated in the zone 30 identified in the overall view of FIG. 1, that the air-oil heat exchanger 40 of the invention is located.

In FIGS. 2 and 3, the air-oil heat exchanger 40 comprises both fins 42 and an oil circuit 43.

The fins 42 are fine ventilation fins disposed on the outside face of the top wall 162 of the separator nose 16. The fins 42 are fine mutually parallel strips that extend substantially from the leading edge 164 of the separator nose 16 to the outlet guide vanes 26, or that come to an end slightly before the outlet guide vanes 26 (as shown in FIG. 2).

These fins 42 are of very small radial extent, which, in combination with their small thickness and their spacing, contributes to disturbing the secondary stream very little where it penetrates into the outer annular air passage 20.

The fins 42 may be parallel to the axis X-X′.

Nevertheless, the fins 42 are preferably not parallel to the axis X-X′ and they are oriented at an acute angle α, preferably lying in the range 40° to 50° relative to the axis X-X′ of the turbojet 10. The fins 42 are advantageously positioned parallel to the direction of the air stream at this location, which air stream has been deflected through an angle of rotation generated by the fan 14.

This angle α serves to limit the impact against the air stream and to maximize the flow rate of air passing between the fins 42.

By way of example, these fins 42 are aluminum strips fitted onto the top surface of the top wall 162 of the separator nose 16 by brazing. Typically, the fins used have a thickness of 1 millimeter (mm) to 2 mm, they are spaced apart at 2 mm to 8 mm, and they present a height (in the radial direction) lying in the range 10 mm to 20 mm.

These fins 42 receive the coolest air since it is the air farthest upstream in the secondary air stream, so the fins benefit from the best available conditions for cooling the top wall 162 of the separator nose 16 in which there is located at least a portion of the oil circuit.

According to the invention, provision is made for the oil circuit 43 to come into contact at least with the top wall 162 of the separator nose 16 so as to benefit from the cooling of the top wall 162 by the fins 42.

In order to reinforce the cooling of the oil circuit by extending the heat exchanger surfaces, and in order to de-ice the inlet guide vanes (IGVs) 24, it is preferable also to provide for the oil circuit 43 also to come into contact with the inside wall 163 of the separator nose 16.

In the first embodiment shown in greater detail in FIG. 2, the oil circuit 43 passes inside the top wall 162 of the separator nose 16 and inside the bottom wall 163 of the separator nose 16.

In this first embodiment, the oil circuit 43 forms a coil disposed within the thickness of the top wall 162 and of the bottom wall 162 of the separator nose 16.

In the configuration shown in FIGS. 2 and 3, the oil circuit 43 travels along the front portion 161 of the separator nose 16 in an essentially circumferential manner, with segments 431 of the oil circuit 43 being annular about the axis (X-X′) of the turbojet and mutually parallel. These almost annular circumferential segments 431 are interconnected by bends 431a (see FIG. 3) so that the oil flow goes from one segment 431 of the oil circuit 43 to the next in a direction opposite to the flow direction of the secondary air stream.

By way of example, these segments 431 of the oil circuit 43 may be hollow channels formed in the thickness of the top wall 162 and of the bottom wall 163.

Alternatively, these channels may also be constituted (see FIG. 8) by the space defined between two plates of a stack of three plates having two parallel plates 437 and 438 that are spaced a small distance apart, with a corrugated third plate 439 being received between them and being connected to the two parallel plates 437 and 438 in leaktight manner via each of the lines forming the crests and the troughs of all of the corrugations. Such a sandwich-type structure presents the advantage of being light in weight and mechanically strong. In addition, by using very fine plates 437, 438, and 439, heat exchange is improved.

Such an arrangement of plates 437, 438, and 439 can itself constitute the walls of the zone constituting the front portion 161 of the separator nose (top wall 162 alone or both top wall 162 and bottom wall 163). Alternatively, the set of plates 437, 438, and 439 may be housed in a dedicated space in the thickness of the top wall 162 (and possibly also the bottom wall 163), e.g. between two other plates or metal sheets constituting the wall in question (162 and possibly 163).

The oil circuit 43 (see FIG. 3) of the air-oil heat exchanger 40 presents an inlet 432 and an outlet 433 that are directly in liquid communication with the general oil circuit of the engine (not shown).

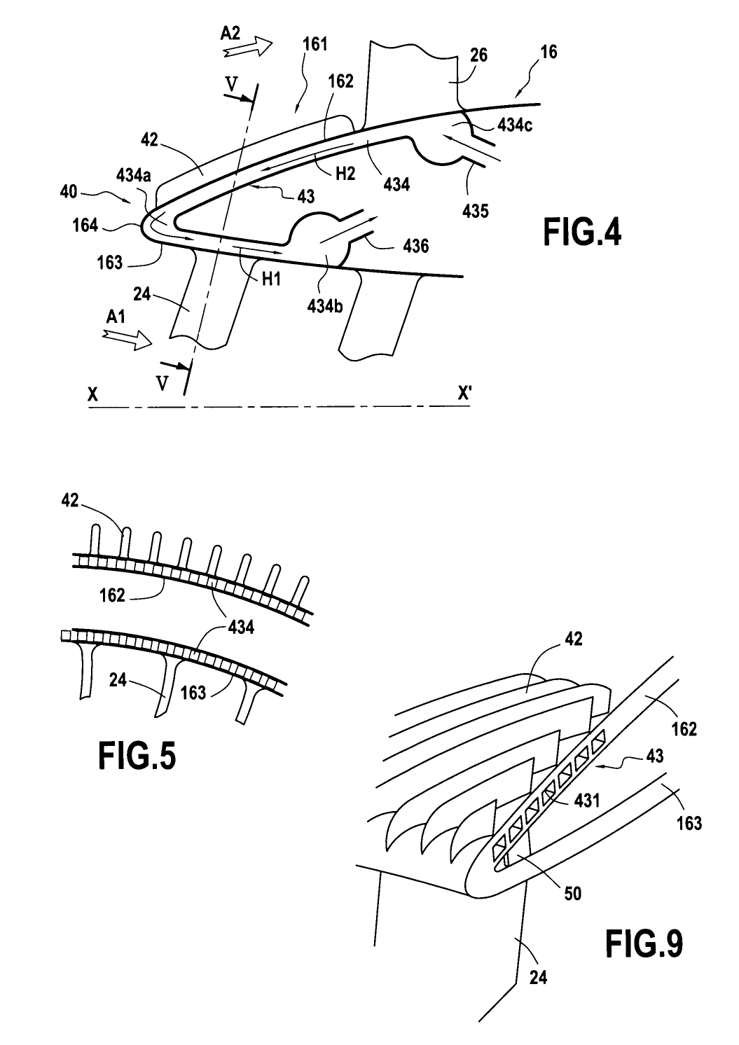

With reference to FIGS. 4 and 5, there is described a variant of the first embodiment in which the oil circuit 43 no longer presents a circumferential oil flow configuration but rather presents an axial oil flow configuration: in this variant, the oil circuit 43 runs along the front portion 161 of the separator nose 16 axially, with mutually parallel oil circuit segments 434 that are also parallel to the axis (X-X′) of the turbojet 10.

The situation shown in FIGS. 4 and 5 corresponds to each oil circuit segment 434 extending axially both in the top wall 162 and in the bottom wall 163, and passing via a bend 434a.

In an alternative (not shown) of this “axial” variant of the first embodiment, it is possible to make provision for the oil circuit 43 to follow a path that is restricted to the top wall 162 of the separator nose 16. Such a configuration also enables the oil flowing past the top wall 162 to be cooled effectively by significant heat exchange with the fins 42 situated on the top face of the top wall 162. Furthermore, under such circumstances, heat exchange takes place between the top wall 162 and the bottom wall 163 via the wall at the leading edge 164 of the separator nose 16.

It should be observed that in this axial configuration of the oil circuit segments 434, oil flowing in the oil circuit either flows in the opposite direction to the stream of air (as shown in FIG. 4 in the portion of the oil circuit traveling along the top wall 162 of the separator nose, represented by oppositely-directed arrows H2 and A2), or else in the same direction as the air stream (as applies in FIG. 4 in the bottom portion of the oil circuit traveling along the bottom wall 163 of the separator nose, represented by two same-direction arrows H1 and A1).

The embodiment shown in FIGS. 4 and 5 corresponds to an arrangement of the oil circuit in which each of the oil circuit segments 434 is fed individually by a common toroidal inlet manifold 435 connected to the top end 434c of the oil circuit segment 434, and delivering individually into a common toroidal outlet manifold 436 connected to the bottom end 434b of the oil circuit segment 434 (see FIG. 4).

Instead of having oil circuit segments 434 that are fed individually, it is possible in a variant that is not shown, to provide a coil using a bend interconnecting two adjacent axially-directed oil circuit segments 434, such bends occurring in alternation at the bottom end 434b and at the top end 434c of these axially-directed oil circuit segments 434. Under such circumstances, the set of axially-directed segments 434 constitutes an oil circuit 43 in the form of a coil.

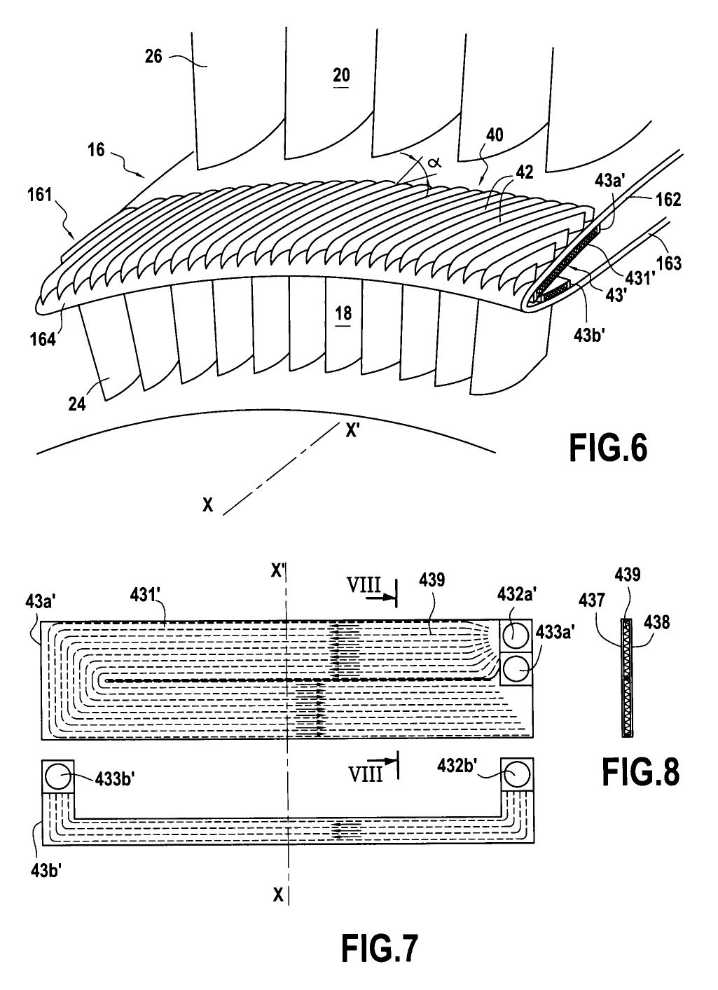

With reference to FIGS. 6 to 8, there can be seen a second embodiment of the air-oil heat exchanger 40, having the following differences compared with the first embodiment of the air-oil heat exchanger described above with reference to FIGS. 2 to 4. Instead of placing the oil circuit 43 in the thickness of the top wall 162 (and possibly also of the bottom wall 163) of the front portion 161 of the separator nose 16 in integrated manner, the oil circuit 43′ is placed outside against the top wall 162, and where appropriate outside against the bottom wall 163, while remaining inside the front portion 161 of the separator nose 16.

In the second embodiment the fins 42 are unchanged and identical to those of the first embodiment.

In FIGS. 6 and 7, the oil circuit 43′ comprises a first oil flow unit 43a′ and a second oil flow unit 43b′.

The first oil flow unit 43a′ is mounted inside the front portion 161 of the separator nose 16, being fastened against the inside face of the top wall 162.

The second oil flow unit 43b′ is mounted inside the front portion 161 of the separator nose 16, being fastened against the top face of the bottom wall 163.

The first and second oil flow units 43a′ and 43b′ are annular and both extend over the full circumferential extent of the front portion 161 of the separator nose 16.

In the axial direction along the axis X-X′ the first oil flow unit 43a′ extends at least over the full length of the fins 42. The second unit may be of smaller axial extent, but it is advantageously placed as close as possible to the leading edge 164 of the separator nose 16 so as to take advantage of the primary air stream in the coldest portion thereof, and also so as to be as close as possible to the first oil flow unit 43a′, thus enabling heat exchange to take place between the units 43a′ and 43b′ via the leading edge 164 of the separator nose 16.

The first and second oil flow units 43a′ and 43b′ contain oil circuit segments 431′ that are annular in the example shown in FIGS. 6 to 8, but in a variant that is not shown, these segments 431′ could be axial (an axial configuration of the kind described above).

In a particular construction, as shown in FIGS. 6 to 8, the first and second oil flow units 43a′ and 43b′ are constituted (see FIG. 8) by a stack of three plates comprising two parallel plates 437 and 438 that are spaced a small distance apart and between which a corrugated third plate 439 is housed, being connected to the two parallel plates 437 and 438 in leaktight manner via each line formed by the crests and the troughs of all of the corrugations. Such a sandwich-type structure presents the advantage of being light in weight and mechanically strong.

Under such circumstances, the space defined between one of the plates 437 and 438 and the corrugated plate 439 forms oil circuit segments 431′ that present a large flow and heat exchange area in a compact configuration.

As can be seen in FIG. 7, which shows both units 43a′ and 43b′ with the separator nose 16 omitted, provision is made for each unit 43a′ (or 43b′) to present a respective inlet 432a′ (or 432b′) and outlet 433a′ (or 433b′) that is in direct liquid communication with the general oil circuit of the engine.

In another variant (not shown) of this second embodiment, only the first oil flow unit 43a′ is used.

In the variant of the first embodiment or of the second embodiment in which the oil circuit is present only at the location of the top wall 162 of the separator nose 16, provision can be made, as shown in FIG. 9 for the first embodiment, for the air-oil heat exchanger 40 also to include a thermal bridge 50 interconnecting the top wall 162 and the bottom wall 163 of the front portion 161 of the separator nose 16.

In FIG. 9, this thermal bridge 50 is a plate interconnecting the bottom face of the top wall 162 in the oil circuit zone to the top face of the bottom wall 163. The thermal bridge 50 is made of one or more materials that are good conductors of heat, such as aluminum.

As a result, there is better transfer heat between the top wall 162 and the bottom wall 163 because of the heat that is conducted via the thermal bridge from the oil circuit of the top wall 162, thereby making it easier to heat the bottom wall 163 for de-icing purposes.

Alternatively, this thermal bridge may be constituted by the fact that the leading edge 164 of the separator nose is solid over a certain axial extent, thereby providing a continuous connection at the leading edge 164 between the top wall 162 and the bottom wall 163 of the front portion 161 of the separator nose 16.

Whether for the first embodiment in which the oil circuit 43 is integrated in the thickness of the walls 162 and 163, or for the second embodiment in which the oil circuit 43′ is fitted against the walls 162 and 163, implementation can be provided either by using continuous annular parts (one-piece oil circuit) or else by using parts that form an annular sectors that are assembled together so as to cover all 360°, like a segmented shell.

Likewise, in the first embodiment or in the second embodiment, the oil circuit 43 or 43′ may form a single circuit extending over the entire circumference of the separator nose 16 or it may be made up of a plurality of secondary circuits, each extending over an annular sector and fed and discharged individually, separately from one another.

It should be observed that the positioning of the fins 42 at the inlet to the outer annular air passage 20 contributes, even if only modestly, to heating the secondary stream, thereby increasing the energy of said secondary stream and thus tending to improve the performance of the engine.

Furthermore, it is observed that the air-oil heat exchanger is placed in the front portion 161 of the separator nose 16 in the zone 30 of FIG. 1, which is a location that does not have any sound damper device such as sound damper panels. However, it should be observed that because of the configuration of the air-oil heat exchanger of the invention, i.e. because of the geometry of the oil circuit and the presence of oil, it provides resistance to the propagation of soundwaves and therefore also performs a sound damper function.

What is claimed is:

1. An air-oil heat exchanger located at the inner shroud of the secondary duct of a turbojet, wherein the heat exchanger comprises an oil circuit placed inside the separator nose and fins placed outside the top wall of the separator nose, between the leading edge of the separator nose and the outlet guide vanes.

2. An air-oil heat exchanger according to claim 1, located in the front portion of the separator nose.

3. An air-oil heat exchanger according to claim 1, wherein the fins are oriented at an acute angle α, preferably lying in the range 40° to 50°, relative to the axis of the turbojet.

4. An air-oil heat exchanger according to claim 1, wherein the oil circuit is in contact at least with the top wall of the separator nose.

5. An air-oil heat exchanger according to claim 4, wherein the oil circuit is also in contact with the bottom wall of the separator nose.

6. An air-oil heat exchanger according to claim 1, wherein the oil circuit passes in the thickness of the top wall of the separator nose.

7. An air-oil heat exchanger according to claim 6, wherein the oil circuit also passes in the thickness of the bottom wall of the separator nose.

8. An air-oil heat exchanger according to claim 1, wherein the oil circuit runs along the separator nose in essentially circumferential manner with the oil circuit having segments that are annular about the axis of the turbojet and mutually parallel.

9. An air-oil heat exchanger according to claim 1, wherein the oil circuit runs along the separator nose in axial manner with oil circuit segments that are parallel to one another and to the axis of the turbojet.

10. An air-oil heat exchanger according to claim 1, wherein the oil circuit is made up of a plurality of secondary circuits each extending over an angular sector and individually fed and discharge separately from the others.

11. An air-oil heat exchanger according to claim 1, further including a thermal bridge interconnecting the top wall and the bottom wall of the separator nose.

12. An air-oil heat exchanger according to claim 1, wherein the oil circuit is fitted against the walls of the separator nose.

13. An air-oil heat exchanger according to claim 12, wherein the oil circuit is in contact at least with the top wall of the separator nose and comprises a first oil flow unit fastened against the bottom face of the top wall and extending at least over the entire length of the fins.

14. An air-oil heat exchanger according to claim 1, wherein the oil circuit is built up from parts forming angular sectors that are assembled together.

15. An air-oil heat exchanger according to claim 1, located in a zone extending to the support struts.

16. An air-oil heat exchanger according to claim 1, wherein the fins extend substantially to the outlet guide vanes.

17. A turbojet including an air-oil heat exchanger according to claim 1 for cooling lubricating oil of the engine and/or equipment-cooling oil.

18. The use of an air-oil heat exchanger according to claim 1 for de-icing the separator nose.
